(19) United States
(12) Patent Application Publication
(10) Pub. No.: US 2016/0266871 A1
(43) Pub. Date: Sep. 15, 2016

(54) SPEECH RECOGNIZER FOR MULTIMODAL SYSTEMS AND SIGNING IN/OUT WITH AND /OR FOR A DIGITAL PEN

(71) Applicant: Adapx, Inc., Seattle, WA (US)

(72) Inventors: Phillipp H. Schmid, Seattle, WA (US); David R. McGee, Seattle, WA (US)

(21) Appl. No.: 15/068,445

(22) Filed: Mar. 11, 2016

Related U.S. Application Data
(60) Provisional application No. 62/131,701, filed on Mar. 11, 2015.

(51) Int. Cl. G06F 3/16; G06F 3/0354; G06F 3/0488; G10L 17/02; G06F 3/0484

(52) U.S. Cl. CPC G06F 3/167; G10L 17/02; G06F 3/04842; G06F 3/04883; G06F 3/03545

(57) ABSTRACT

A multimodal system using at least one speech recognizer to perform speech recognition utilizing a circular buffer to unify all modal events into a single interpretation of the user's intent.

### PRIORITY CLAIM

This application claims priority to U.S. Provisional Patent Application Nos. 62/131,701 filed on Mar. 11, 2015 and 62/143,389 filed on Apr. 6, 2015.

This application is a continuation in part of U.S. patent application Ser. No. 12/131,848 filed on Jun. 2, 2008 now U.S. Pat. No. 8,719,718 issued on May 6, 2014 which claims priority to U.S. Provisional Patent Application No. 60/941,332 filed on Jun. 1, 2007 and is a continuation-in-part of U.S. patent application Ser. No. 12/118,656.

This application is a continuation in part of U.S. patent application Ser. No. 14/299,966 filed on Jun. 9, 2014 which is a continuation of U.S. patent application Ser. No. 13/206,479 filed on Aug. 9, 2011 which claims priority to U.S. Provisional Patent Application Nos. 61/427,971 filed on Dec. 29, 2010 and 61/371,991 filed on Aug. 9, 2010.

This application is a continuation in part of U.S. patent application Ser. No. 14/622,476 filed on Feb. 13, 2015 which is a continuation of U.S. patent application Ser. No. 12/750,444 filed on Mar. 30, 2010 which claims priority to U.S. Provisional Patent Application No. 61/165,398 filed on Mar. 31, 2009.

This application is a continuation in part of U.S. patent application Ser. No. 14/151,351 filed on Jan. 9, 2014 which is a reissue of U.S. patent application Ser. No. 11/959,375 filed on Dec. 18, 2007 now U.S. Pat. No. 8,040,570 issued on Oct. 18, 2011 which claims priority to U.S. Provisional Patent Application No. 60/870,601 filed on Dec. 18, 2006. Each of the foregoing applications are herein incorporated by reference in their entirety.

### FIELD OF THE INVENTION

In multimodal systems the timing of speech utterances and corresponding gestures changes from user to user and task to task. Sometimes, the user will start to speak and then gesture (e.g., mentions the type of military unit to place on a map before gesturing the exact location on a map) and sometimes the reverse is true (gesture before speech). The latter case (gesture before speech) is easily supported in multimodal systems by simply activating the speech recognizer once a gesture has occurred. The former case however (speech before gesture) is problematic. What can we do to not lose speech that was uttered prior to the gesture? The approach described below addresses this issue in a simple and elegant way.

### BACKGROUND OF THE INVENTION

A multimodal system uses at least one speech recognizer to perform speech recognition. The speech recognizer is using an audio object to abstract away the details of the low-level audio source. The audio object is receiving sound data (often in the form of raw PCM data) from the operating system's audio subsystem (e.g., WaveIn® in the case of Windows®).

The typical order of events is as follows:
1. Non-speech interaction with the multimodal system (e.g., touching of a drawing or a map with a finger, a pen, or other input device)
2. Multimodal application turns on the speech recognizer to make sure that any utterance(s) by the user is captured and recognized so that the information can be unified (fused) with the other modal inputs to derive the correct meaning of the user's intention
3. Speech recognizer asks the audio object for speech data
4. User's speech is recorded by the microphone and returned to the audio object via the operating system's audio subsystem
5. Audio object returns speech data to the speech recognizer (answers the request in step 3)
6. Speech recognizer recognizes speech and once a final state in the speech grammar is reached (or the recognizer determines that the user did not utter a phrase expected by the system) raises an event to the multimodal application with the details of the speech utterance

At this point the multimodal application will try to unify all modal events into a single interpretation of the user's intent.

To further illustrate this process and to demonstrate the issue raised in the introduction, let's first assume that the user is first touching a display map with his stylus and then speaks the following utterance:
“This is my current location”

Because the user first creates a non-speech event (by touching the map), by the time he starts speaking, step 4 will have happened and all of the uttered speech will be processed by the system.
Next, the user utters:
“How far is it to this intersection?”

The user touches the map display as he utters the word “this”. Therefore, the first few words (“How far is it to”) occur before the speech recognizer is activated in step 2, and are not being processed by the speech recognizer.

The custom audio object described below addresses the issue just described.

### BRIEF DESCRIPTION OF THE DRAWINGS

Preferred and alternative examples of the present invention are described in detail below with reference to the following drawings:

FIG. 1 depicts a multimodal application order of events of an exemplary embodiment.

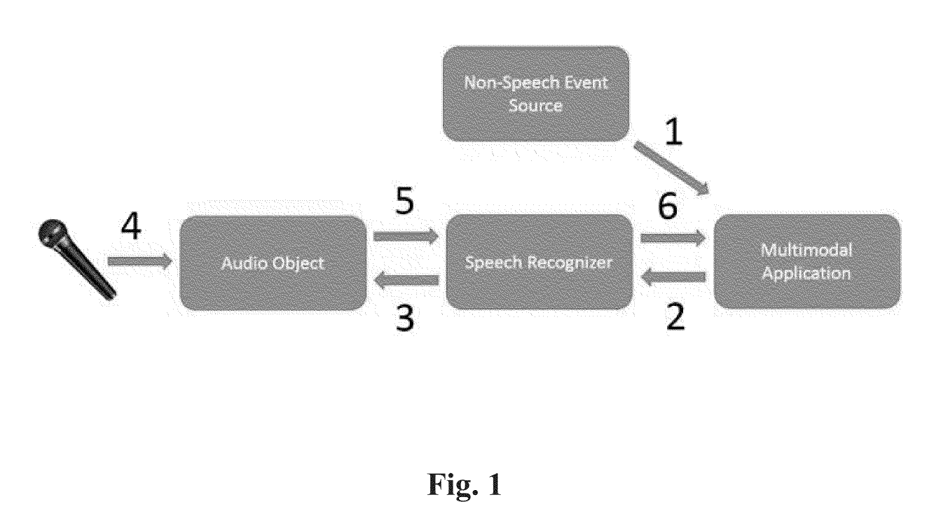

FIG. 2 depicts a circular buffer used by a custom audio object of an exemplary embodiment.

### DETAILED DESCRIPTION OF THE PREFERRED EMBODIMENT

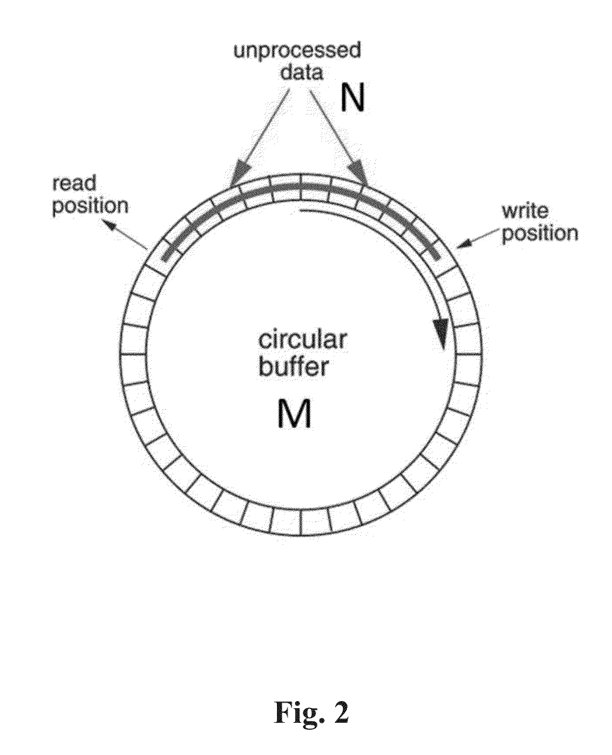

In order to be able to deal with the case where the user of the multimodal system starts speaking before performing a gesture, a history of the recent audio data needs to be kept. This is accomplished by using a circular buffer inside the audio object (see FIG. 2). If we want to recognize speech spoken N seconds prior to a gesture, then we need a buffer large enough to hold at least N seconds of unprocessed speech data. Once the recognizer is ready to process speech data, instead of returning the most recent speech data, the audio object is returning the speech data beginning at most N seconds prior (read position in FIG. 2). Since most modern speech recognizers can process audio data faster than real-time, the processing will eventually catch up to real-time and the user will not perceive any noticeable delay.

The audio object starts out accumulating the most recent N seconds of speech by continuously writing new audio data to the circular buffer (overwriting obsolete data after M seconds). In this state the read position is irrelevant.

Once the speech recognizer is activated (step 2 above) and therefore the audio object is activated (step 3 above), the read position is set to N seconds in the past of the current write position. From that moment on, any calls by the recognizer to the audio object for additional speech data will advance the read pointer up to the point where the read position has caught up with the write position. At that point any read call by the recognizer is blocked until more audio data is available (write position has advanced).

Some consideration will have to be given to the size of the circular buffer (M>N), since there will be moments where the write pointer could potentially ‘lap’ the read pointer (if there is a delay in processing the speech, especially at the beginning of the processing) if the buffer isn't large enough.

Once the speech recognizer is deactivated it will cease to request audio data from the audio object. That will leave the read pointer of the audio object at its current location. No error condition should be raised at that point as the write pointer will lap the read pointer eventually. Subsequent activations will reset the read pointer to lag the write pointer by N seconds and normal operations as describe above will commence.

While the preferred embodiment of the invention has been illustrated and described, as noted above, many changes can be made without departing from the spirit and scope of the invention. For example, signing in/out with and/or for a digital pen—Grab any digital pen from inventory, ign next to your name/employee number/email address (on the report from Pen Status). (See Pen Status Report description, below.) Signature is verified digitally against previously approved and verified (via badge, Driving License, etc.). If validation succeeds, pen (with serial number used on that employee line) is checked out to that same Capturx Server user. Checkout email is sent to the email in Pen Status list. Process is reversed upon check in with once again the user signing to checkout.

A simplification does not compare against a digital signature or even sign, but simply check a box. In environments where other controls are in place a simple checking of a box by someone's name could check out a pen to that person and vice versa.

Pen Status Report—a Capturx document that a Capturx Server admin can request that enumerates all of the possible legal pen users in the Capturx Server, their email addresses, names, and a signature field for signing that same name. An accompanying database field also contains a key for comparing that dynamically collected signature to one previously and legally captured for comparison.

The report is printed on digital paper so that it can be signed itself with a digital pen on the signature field by the employee, etc. signing out an individual pen.

In an alternate embodiment, the employee is the one being signed in or out and the pen is used as a physical part of a 3-part security apparatus.

Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A multimodal system configured to store recorded speech uttered prior to a speech indicator, said speech indicator selected from the group comprising touching of a document with a finger, touching of a document with a pen, and touching of a document with another input device.

2. The system of claim 1 wherein the document is selected from the group comprising a map and a drawing.
